(19) United States
(12) Patent Application Publication
(10) Pub. No.: US 2015/0257393 A1
(43) Pub. Date: Sep. 17, 2015

(54) SEED TREATMENT COMPOSITIONS AND METHODS CONTAINING NON-FLAVONOID INDUCED RHIZOBIUM DERIVED METABOLITES

(71) Applicant: GREEN & GROW, INC., Mesa, AZ (US)

(72) Inventors: Gary Michael NIJAK, JR., Austin, TX (US); Mark O'DONNELL, Austin, TX (US); Samuel Jacob VIGUE, Brimfield, IL (US)

(73) Assignee: GREEN & GROW, INC., Mesa, AZ (US)

(21) Appl. No.: 14/204,726

(22) Filed: Mar. 11, 2014

(51) Int. Cl. A01N 63/02; A01N 43/36; A01N 37/22; A01N 47/26; A01N 43/78; A01N 43/88; A01N 43/653; A01N 43/50; C05G 3/00; A01N 43/54

(52) U.S. Cl. CPC A01N 63/02; C05G 3/00; A01N 43/36; A01N 37/22; A01N 43/54; A01N 43/78; A01N 43/88; A01N 43/653; A01N 43/50; A01N 47/26

(57) ABSTRACT

A product including at least one Rhizobium spp. derived metabolite and a seed treatment material is disclosed. The seed treatment material can include a fungicide, an insecticide, a plant growth regulator, a plant growth promoter, a micronutrient, and combinations thereof. Methods for producing the product are disclosed. Methods for using the product are disclosed, including a method for applying a product to one or more seeds. Applying the product can increase the overall yield of the plants grown from the treated seed as compared to plants grown from seeds not treated with the product.

### BACKGROUND OF THE INVENTION

1. Field of the Invention

The invention relates generally to a composition of materials containing a rhizobium derived composition that when combined with conventional and novel seed treatment technologies promotes growth of all types of plants.

2. Description of the Related Art

Information relevant to attempts to address these problems can be found in the following references, which are not admitted to be prior art with respect to the present invention by inclusion in this section:
(1) Farooq, M., A. Wahid, and Kadambot H M Siddique. “Micronutrient application through seed treatments: a review.” Journal of soil science and plant nutrition 12.1 (2012): 125-142;
(2) Hairston, Bill. “The Evolution of Modern Seed Treatments.” Outlooks on Pest Management 24.4 (2013): 184-186;
(3) Munkvold, Gary P. “Seed pathology progress in academia and industry.” Annual review of phytopathology 47 (2009): 285-311;
(4) PRWeb. “BCC Research Publishes a New Report on Global Markets for Seed Treatment.” PRWeb. N.p., 31 Oct. 2013. Web. 21 Jan. 2014; and
(5) Taylor, A. G., et al. “Seed enhancements.” Seed Science Research 8.2 (1998): 245-256.
   However, each one of these reference suffers from one or more disadvantages, which are not admitted to have been known in the art by inclusion in this section.

Seed treatments are a significant and growing industry with an estimated $3.2 billion value as of 2013. Over the next 5 years they're expected to have an annual compounded growth rate of more than 8 percent reaching $4.8 billion by 2018 (PRWeb, 2013). The quick growth rates in the seed treatment industry have been catalyzed through the increased role of the seed in agriculture as a high-value input. This has occurred as biotechnological advances have increased the expectations of producers for maximum performance of input and output traits (Munkvold, 2009).

Use of highly automated precision equipment in the seed treatment industry has allowed precise chemical prescriptions to be developed for many individual crop species. Treated seeds have become standard for many crops, and continue to improve stands and vigor potential for growers (Kaufman, 1991). Seed treatment, therefore, provides a highly economical method for maximizing food production world-wide, and will play a significant global role in reducing food insecurity and feeding a growing population.

The use of seed treatments allows for the close proximity of active materials to the seed and, thus, can induce an effective and rapid response. The intended responses include pest control, plant health through nutrition, and disease control. The development of systemic fungicides and insecticides that provide residual pest control after the emergence of the seedlings has greatly expanded the use and effectiveness of seed treatments as well as the number of seed treatment products on the market today (Hairston, 2013).

A variety of novel seed enhancement technologies and application methods have continued to be developed for an increasing number of products. These enhancement technologies include priming, pelleting, film coating, and encrustation. Various actives and inert substrates such as polymers, colorants, and fillers are combined to give the desired final product (Taylor et. al, 1998). The scope of use for these treatment technologies is very broad and includes all agricultural and horticulture crops ranging from grains and fibers to vegetables and ornamentals including turfgrass, although often efficacy is questionable and has resulted in a lack of adoption.

Traditional seed treatments include fungicides and insecticides in varying combinations to promote early growth of the plant. Chemical stimulants such as gibberellic acids and other stimulants promote early growth and germination of the seed. Macronutrients are sometimes used to provide starter nutrients at germination. Also, micronutrient deficiencies in the soil can be corrected by applying micronutrients as a seed treatment due to the very small quantity required by plants (Farooq, 2012). These materials, combined with enhancement techniques such as priming, pelleting, encrustation, and precision coating, have significantly advanced the efficacy of seed treatments and, thus, have improved agriculture as a whole.

However, a need remains for biologically derived products that are non-toxic, do not rely on the action of a living organism, are compatible with other products used in agriculture, and have a robust biostimulation of the plant and provide efficacy that is not crop specific or limited to certain crops.

### BRIEF SUMMARY OF THE INVENTION

The present invention meets the above-identified needs by providing a composition containing a metabolite mixture derived from a Rhizobium spp. bacteria that can be applied with various seed treatment packages and that can provide significant and unexpected benefits across a range of crops. The ability of these types of derived materials to provide additional benefits to a seed treatment package on top of an existing optimized, extensively researched, and complex package is unexpected, novel, and significant.

One embodiment relates to a product including at least one Rhizobium spp. derived metabolite and a seed treatment material. The seed treatment material can include a fungicide, an insecticide, a plant growth regulator, a plant growth promoter, a micronutrient, and combinations thereof.

According to various embodiments, the Rhizobium spp. derived metabolite is not derived from a lipochitooligosaccharide (LCO). The fungicide can be, but is not limited to, metalaxyl, carboxin, menfenoxam, triticonazole, fludioxonil and combinations thereof. The insecticide can be, but is not limited to, imidacloprid, thiamethoxam, clothianidin, cyromazine, permethrin and combinations thereof. The plant growth regulator or promoter can be, but is not limited to, gibberellic acid, cytokinin, indolebutyric acid, kelp, indoleacetic acid, amino acid and combinations thereof. The micronutrient can be, but is not limited to, zinc, copper, iron, molybdenum, manganese, and combinations thereof. The nematicide can be, but is not limited to abamectin, harpin, spinosad, chitin and combinations thereof.

According to various embodiments, the product can be produced by a process including, but not limited to the steps of adding a broth to a biological reactor, culturing the broth to produce a culture containing Rhizobium derived metabolites; terminating viability of the culture; and adding the seed treatment material to the culture to make a seed treatment composition. The broth can include a carbon source, the carbon source including at least one monosaccharide and at least one higher order saccharide; a source of nutrients, the source of nutrients comprising at least one phosphate, a nitrogen source, at least one source of magnesium; and a Rhizobium spp. The step of terminating viability of the culture can be performed by lysis, stabilization, thermal treatment, combinations thereof, and other suitable methods.

The seed treatment composition can be concentrated 2 to 10 times to produce a final composition that has an increased concentration of Rhizobium derived metabolites. The Rhizobium spp. can be a Rhizobiaceae. The Rhizobiaceae can be, but is not limited to, Rhizobium etli, Rhizobium leguminosarum, Rhizobium phaseoli, Rhizobium tropici, Rhizobium fredii, Rhizobium meliloti, and combinations thereof.

Various embodiments relate to a method comprising applying a product to one or more seeds. The product can include at least one Rhizobium spp. derived metabolite and a seed treatment material. The seed treatment material can include, but is not limited to, a fungicide, an insecticide, a plant growth regulator, a plant growth promoter, and combinations thereof. The product can be applied by a method including, but not limited to, film coating, encrusting, pelleting, priming, film coating, drenching, and combinations thereof. The product can be applied at a rate of from 0.00025 to 10 mg per seed.

Applying the product can increase the overall yield of the plants grown from the treated seed as compared to plants grown from seeds not treated with the product. Applying the product can increase the harvestable fruit by at least 0.5 bushels per acre as compared to plants grown from seeds not treated with the product. Applying the product can increase the harvestable foliage by at least 5% as compared to plants grown from seeds not treated with the product. Applying the product can promote the overall growth of the plant for the treated seed as compared to plants not treated with the product. Applying the product can increase the overall growth of the plant for the treated seed as compared to the plants not treated with the product by at least 5% of the maximum above ground length.

Various embodiments relate to a method for producing a product that includes at least one Rhizobium spp. derived metabolite and a seed treatment material. The seed treatment material can include, but is not limited to a fungicide, an insecticide, a plant growth regulator, a plant growth promoter, and combinations thereof. The method can include, but is not limited to the steps of adding a broth to a biological reactor, culturing the broth to produce a culture; terminating viability of the culture; and adding the seed treatment material to the culture to produce the product. The broth can include a carbon source, the carbon source including at least one monosaccharide and at least one higher order saccharide; a source of nutrients, the source of nutrients comprising at least one phosphate, a nitrogen source, at least one source of magnesium; and a Rhizobium spp. The step of terminating viability of the culture can be performed by lysis, stabilization, thermal treatment, and combinations thereof.

Various embodiments relate to a method of manufacturing a seed treatment composition, the seed treatment composition including at least an exudates produced by Rhizobium spp. and one other seed treatment material. More specifically, the method can include, but is not limited to the steps of cultivating a composition; adding a broth to a biological reactor, allowing a culture of bacteria to grow in an aerobic biological reactor for 2-6 weeks; adding at least one additional part carbon source to maintain the reactor in at least an excess of 4:1 of carbon to nitrogen to induce metabolite production; stabilizing the Rhizobium spp. derived composition by concentrating the material rapidly by either spray drying, flash drying, vacuum drying or evaporation; and adding to the composition at least one other seed treatment material consisting of at least one fungicide. The broth can include a carbon source consisting of at least one monosaccharide and at least one higher order saccharide; a source of nutrients including one or more phosphates, a nitrogen source, at least one source of magnesium; and a Rhizobium spp.

### BRIEF DESCRIPTION OF THE DRAWINGS

These and other features, aspects, and advantages of the present invention will become better understood with reference to the following description and appended claims, and accompanying drawings where:

FIG. 1: is an HPLC spectra demonstrating a lack of LCOs in the Rhizobium spp. derived composition

FIG. 2: is a chart plotting romaine lettuce shoot length against Rhizobium spp. derived composition percentage;

FIG. 3: is a chart showing Corn seed treatment comparison between Rhizobium spp. derived composition plus chemical combination versus composition without Rhizobium spp. derived composition;

FIG. 4: is a chart showing Soybean seed treatment comparison between Rhizobium spp. derived composition plus chemical combination versus composition without Rhizobium spp. derived composition; and

FIG. 5: is a chart showing Soybean seed treatment comparison between Rhizobium spp. derived composition plus chemical combination versus composition without Rhizobium spp. derived composition;

It should be understood that the various embodiments are not limited to the arrangements and instrumentality shown in the drawings.

### DETAILED DESCRIPTION OF THE INVENTION

The present invention may be understood more readily by reference to the following detailed description of preferred embodiments of the invention as well as to the examples included therein. All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

As used herein terms Rhizobium derived, Rhizobium exudate, derived by Rhizobium, Rhizobium produced, produced by Rhizobium means a composition that is derived from maintaining a culture of Rhizobium in stationary phase for an extended period of time (at least 20 days after achieving stationary phase), in a highly enriched carbon environment as compared to the nitrogen content of the culture (in excess of 4 to 1 and preferred to be above 10 to 1) during the entire stationary phase to induce the production of exudates of which the bulk exudate will be an exopolysaccharide. At no point are flavonoids introduced which are typically considered a means to produce lipochitooligosaccharides, a known exudate that has beneficial plant and bacteria interactions. After at least 20 days in stationary phase, the culture is then thermally lysed and concentrated denaturing any unstable exudates in the mixture and terminating the viability of the culture. The then produced exudates exhibit a response and interaction with living biologicals which is not solely due to the production of vitamins such as B-12, hormones such as auxin, cytokin, gibberrilic acid, indole acetic acid, ACC deaminase (1-aminocyclopropane-1-carboxylate) or plant signaling compounds such as lipochitooligosaccharides or due to the exopolysaccharide contained within the metabolite mixture. All of these chemicals are measurable by assays known in the literature.

To produce the Rhizobium spp. derived composition, the biological reactor can be aerated to an aerobic state and fed the raw materials necessary for the culture. The batch can be feed every other day with a sugar source. The suitable period of time can be within a range having a lower limit and/or an upper limit. The range can include or exclude the lower limit and/or the upper limit. The lower limit and/or upper limit can be selected from 1, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 55, 60, 65, 70, 75, 80, 85, 90, 95, 100, 110, 120, 130, 140, 150, 160, 170, 180, 190, 200, 300, 400, 500, 600, 700, 800, 900, and 1000 days. For example, the suitable period of time for allowing the materials to remain in the biological reactor can be from 20 to 49 days. The reactor can be brought to full volume by expanding the culture and maintaining a sugar concentration below a Brix of 1.5 such that the free or unutilized sugar concentration is reduced to nearly zero once the bacteria reach steady state. These steps can be repeated until the bacteria culture reaches full volume. Once the full reactor volume is achieved, the sugar can be spiked. The suitable level of carbon to nitrogen within the culture can be within a range having a lower limit and/or an upper limit. The range can include or exclude the lower limit and/or the upper limit. The lower limit and/or upper limit can be selected from 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 55, 60, 65, 70, 75, 80, 85, 90, 95, 100, 110, 120, 130, 140, and 150 C:N ratio. For example, the suitable C:N for allowing the materials to produce the Rhizobium spp. derived metabolites can be from 10-120 C:N ratio and maintained at this level+/−10 C:N. During this time the bacteria culture can be maintained in a decay rather than growth stage, i.e. the number of viable cells is decreasing. The C:N ratio can be increased once the tank has reached steady state. The tank after the appropriate period can be treated to lyse the cells and evaporate the material into a condensed form. The suitable level of concentration of the culture composition can be within a range having a lower limit and/or an upper limit. The lower limit and/or upper limit can be selected from 1.5, 2, 2.5, 3, 3.5, 4, 4.5, 5, 6, 7, 8, 9, 10, 11, 12, 13, 14, and 15. For example, the suitable concentration factor to produce the concentrated composition can be from 2-10 times. In doing so, unstable metabolites are degraded in the final composition. No flavonoids are introduced into the process which results in a mixture that does not contain flavonoid induced products such as lipochitooligosaccharides (LCOs). Once the reactor is determined to reach its maximum concentration, the material can be thermally treated to below boiling and concentrated by evaporation.

Any unstable materials in the composition are thus degraded. This material does not contain unstable materials such as LCOs and the concentration process eliminates and would degrade any of these materials if they were to be produced in the culturing process. To this non-living, non-viable culture material, a microbial growth inhibitor such as an alkaline material like sodium hydroxide can be added. Additional amendments and combinations can be added to this Rhizobium spp. derived composition.

The broth in which the Rhizobium spp. materials are cultured can include at least a nitrogen source, sugar source, and magnesium sulfate. The nitrogen source suitable level of concentration of the culture composition can be within a range having a lower limit and/or an upper limit. The lower limit and/or upper limit can be selected from 0.005, 0.006, 0.007, 0.008, 0.009, 0.01, 0.011, 0.012, 0.013, 0.014, 0.015, 0.016, 0.017, 0.018, 0.019, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, and 10% of the culture by weight. For example, the suitable nitrogen source concentration to produce composition can be from 0.005 to 0.5% by weight of the culture composition. The sugar source suitable level of concentration of the culture composition can be within a range having a lower limit and/or an upper limit. The lower limit and/or upper limit can be selected from 0.05, 0.10, 0.20, 0.30, 0.40, 0.50, 0.60, 0.70, 0.80, 0.90, 1.0, 1.1, 1.2, 1.3, 1.4, 1.5, 2, 3, 4, 5, 6, 7, 8, 9, 10, 11, 12, 13, 14, 15, 16, 17, 18, 19, 20, 21, 22, 23, 24, 25, 26, 27, 28, 29, and 30% by weight of the culture. For example, the suitable sugar source concentration to produce composition can be from 0.05 to 15% by weight of the culture composition. The magnesium sulfate suitable level of concentration of the culture composition can be within a range having a lower limit and/or an upper limit. The lower limit and/or upper limit can be selected from 0.0005, 0.0010, 0.0020, 0.0030, 0.0040, 0.0050, 0.0060, 0.0070, 0.0080, 0.0090, 0.010, 0.011, 0.012, 0.013, 0.014, 0.015, 0.2, 0.3, 0.4, 0.5, 0.6, 0.7, 0.8, 0.9, and 0.10% by weight of the culture. For example, the magnesium sulfate concentration to produce composition can be from 0.005 to 0.10% by weight of the culture composition. The remaining portions of the culture can be water. The mixture of a nitrogen source, sugar source, magnesium sulfate, a phosphate and an innoculum of Rhizobium spp. bacteria can be added to a reactor. More specifically, Rhizobium tropici can be utilized. Rhizobium bacteria can be selected from Rhizobium alamii, Rhizobium alkalisoli, Rhizobium cellulosilyticum, Rhizobium daejeonense, Rhizobium endophyticum, Rhizobium etli, Rhizobium galegae, Rhizobium gallicum, Rhizobium giardinii, Rhizobium hainanense, Rhizobium herbae, Rhizobium huautlense, Rhizobium indigoferae, Rhizobium leguminosarum including biovars viciae, phaseoli, and trifolii, Rhizobium loessense formerly Rhizobium huanglingense, Rhizobium lusitanum, Rhizobium mesosinicum, Rhizobium miluonense, Rhizobium mongolense, Rhizobium multihospitium, Rhizobium oryzae, Rhizobium phaseoli, Rhizobium pisi, Rhizobium tibeticum, Rhizobium sullae formerly Rhizobium hedysari, Rhizobium tropici, Rhizobium tubonense, Rhizobium undicola formerly Allorhizobium undicola, Rhizobium vignae, Rhizobium yanglingense, Mesorhizobium albiziae, Mesorhizobium alhagi, Mesorhizobium amorphae, Mesorhizobium australicum, Mesorhizobium camelthorni, Mesorhizobium caraganae, Mesorhizobium chacoense, Mesorhizobium cicero formerly Rhizobium cicero, Mesorhizobium gobiense, Mesorhizobium huakuii formerly Rhizobium huakuii, Mesorhizobium loti formerly Rhizobium loti Mesorhizobium mediterraneum formerly Rhizobium mediterraneum, Mesorhizobium metallidurans, Mesorhizobium opportunistum, Mesorhizobium plurifarium, Mesorhizobium robiniae, Mesorhizobium shangrilense, Mesorhizobium septentrionale, Mesorhizobium tarimense, Mesorhizobium temperatum, Mesorhizobium tianshanense formerly Rhizobium tianshanense, Ensifer abri, Sinorhizobium americanum, Ensifer arboris, Ensifer fredii formerly Rhizobium fredii former Type of Sinorhizobium G, Ensifer garamanticus, Ensifer indiaense, Ensifer kostiensis, Ensifer kummerowiae, Ensifer medicae, Ensifer meliloti formerly Rhizobium meliloti, including biovars phaseoli, gallicum, giardinii, and mediterranense Ensifer mexicanus, Sinorhizobium morelense, Ensifer adhaerens, Ensifer numidicus, Ensifer saheli, Ensifer sojae, Ensifer terangae, Bradyrhizobium canariense, Bradyrhizobium denitrificans formerly Blastobacter denitrificans, Bradyrhizobium elkanii, Bradyrhizobium iriomotense, Bradyrhizobium japonicum formerly Rhizobium japonicum including biovars glycinae, vignaea, and lupinea Bradyrhizobium jicamae, Bradyrhizobium liaoningense, Bradyrhizobium pachyrhizi, and Bradyrhizobium yuanmingense.

Amendments that can be added to the Rhizobium spp. culture derived composition have desirable properties that improve the final functionality of the seed treatment. These can include but are not limited to; Herbicides such as ACCase inhibitors, ALS inhibitors (pyrimidinyl oxybenzoates, triazolopyrimidines, sulfonylureas, imidazolinones, and sulfonylamino carbonyl triazolinones), carbamates, triazines, glycerol ethers, EPSPS inhibitors (glyphosate), Synthetic auxins (2,4-D, 2,4-DB, 2,4-DP, MCPA, MCPB, MCPP), acetamides, dinitroanilines, bipirydiums (diquat and paraquat), diphenilethers (nitrofen, nitrofluorfen, and acifluoren), pyridazinones, uracils, phenoxys, ureas, and benzoic acids growth regulators, pigment inhibitors, and photosystem inhibitors; Seed treatment herbicides which can include clopyrallid, dicamba, imazapyr, picloram, prosulfuron, and Phomopsis amaranthicola; Herbicide safeners such as fluxofenim, benzoxazine, benzhydryl deriviatives, N,N-diallyl dichloroacetamide, dihaloacyls, oxazolidinyls, thiazolidinyls, ethanone, naphthalic anhydrides, and oxime derivatives; Algicides such as copper sulfate, hydrogen peroxide, and peracetic acid; Avicides; Bactericides (acibenzolar —S-methyl, bacteriophages, chlorine, copper sulfate, high valency silver, hot water, oxidized copper, sodium hypochlorite, streptomycin, and streptomycin sulfate); Fungicides (anilinopyrimidines, benzamidazoles, carboxamides, diazines, diazoles, dicarboximides, dithiocarbamates, methyl benzimidazole carbamates, morpholines, natural fungicides, phenylamides, phenylpyrroles, pyrazoles, strobilurins, and triazoles), acibenzolar-s-methyl, ametotradin, amisulbrom, anilazine, arsenates, azoxystrobin, benalaxyl, benthiavalicarb, bixafen, boscalid, captan, carbendazim, carboxin, Chenopodium quinoa saponins, chloroneb, chlorothalonil, copper hydroxide, cyazofamid, cyflufenamid, cyproconazole, cyprodinil, difenoconazole, dimethomorph, ethaboxam, ethyl mercaptan, etridiazole, fenamidone, fenpropidin, fluazinam, fludioxonil, flumorph, fluopicolide, fluopyram, fluoxastrobin, flusulfamide, flutriafol, high valency silver, hydrogen dioxide, hymexazol, imazalil, ipconazole, iprovalicarb, isopyrazam, kresoxim-methyl, mancozeb, mandipropamid, maneb, mefenoxam, metalaxyl, metalaxyl-m, metconazole, myclobutanil, penconazole, penflufen, pentachloronitrobenzene, penthiopyrad, phosphorus acid, plant extracts, plant oils, propiconazole, propineb, prothioconazole, pyraclostrobin, Reynoutria sachalinensis, sedaxane, tebuconazole, thiabendazole, thiophanate methyl, thiram, triadimefon, triadimenol, trifloxystrobin, trisodium phosphate, triticonazole, and valifenalate; Insecticides such as neonicotinoids (acetamiprid, clothianidin, dinotefuran, imidacloprid, nitenpyram, nithiazine, sulfoxaflor, thiacloprid, and thiamethoxam etc.), carbamates (carbofuran etc.), insect growth regulators (cryomazine etc.), organochlorides, organophosphates (chlorpyrifos etc.), plant extracts and oils, pyrethroids (cypermethrin, lambda cyhalothrin, cyfluthrin, bifenthrin, fenvalerate 6 esfenvalerate, beta-cypermethrin, zeta-cypermethrin, deltamethrin, fenpropathrin, taufluvalinate, flucythrinate, flumethrin, beta-cyfluthrin, trans-cyfluthrin, acrinathrin, alphacypermethrin, tralomethrin, cycloprothrin, kadethrin, resmethrin, bioresmethrin, tetramethrin, phenothrin, empenthrin, cyphenothrin, prallethrin, imiprothrin, allethrin, bioallethrin, permethrin, tefluthrin), cyantraniliprole, fipronil, neem, spinosad and pymetrozine; Miticides (Acaracides); Molluscicides; Nematicides (abamectins, chitin protein, harpin proteins, imidacloprid, Quercus spp. extract, Quillaja saponaria, sesame oil, thyme oil, and thiocarb); Rodenticides; Virucides; Bird repellents such as anthraquinone and methiocarb; Macronutrients such as nitrogen (ammonium sulfate, ammoninum nitrate, urea), phosphorus (monoammonium phosphate, diammonium phosphate, bone meal,), potassium (potash, potassium chloride), calcium (calcium chloride, calcium sulfate, calcium nitrate, gypsum, calcium acetate), magnesium (magnesium chloride, magnesium sulfate, magnesium ammonium phosphate), and sulfur (ammonium sulfate, magnesium sulfate, gypsum); Micronutrients such as boron (borax), chlorine, copper (copper sulfate), iron (iron sulfate, iron chelate), manganese, molybdenum (sodium molybdate), nickel, and zinc (zinc oxide, zinc sulfate, zinc chelate); Beneficial elements such as cobalt, sodium, silicon, and selenium; Chelators and chelated nutrients such as those chelated with EDTA or HEDTA or nano chelated nutrients; Traditional soil amendments such as manure, mulch/compost, peat, sawdust, bone meal, bentonite, clays, and polymers; Plant growth hormones, regulators, inhibitors, modifiers, defoliants, and retardants such as auxinolonic acid, heteroauxin, florigen, fusicoccin, indolacetic acid, indolbutyric acid, cytokinins, allogibberic acid, kinetin, zeatin, benzyladenine, gibberellic acids, ancymidol, butralin, carbaryl, chlorphonium, chlorpropham, dikegulac, flumetralin, fluoridamid, fosamine, glyphosine, isopyrimol, maleic, hydrazide, piproctanyl, prohydrojas-mon, propham, indolylacetonitrile, triacontanol, abscisic acids, ethylene, ethylene inhibitors, brassinolides, forchlorfenuron, hymexazol, indolinone, brassinosteroids, morphactin, aminotriazole, chloroethylphosphonic acid, jasmonic acids, salicylic acids, mepiquat salts, 1-methylcyclopropane, aviglycine, 1-naphthnaleneacetic acid, chlormequat chloride, mepiquat, mepiquat pentaborate, chlorofluren, chloroflurenol, dichloroflurenol, flurenol, daminozide, flurprimidol, mefluidide, paclobutrazole, cyproconazole, tetcyclacis, uniconazole, karrikins, clofibric acid, 2,3,5-tri-iodobenzoic acid, 2,4-dichlorophenoxy acetic acid, dichloroprop, fenoprop, naphthalene acetamide, 1-naphthole, naphthoxy acetic acid, potassium naphthenate, sodium naphthenate, calcium, cyanimide, dimethipin, endothal, ethephon, merphos, metoxuron, pentachlorophenol, thidiazuron, tribufos, ACC, etacelasil, and glyoxime; Plant growth promoters such as chitins, adenosine monophosphate, harpin proteins, isoflavenoids, polyamines, lipo-chitooligosaccharides, lipopolysaccharides, exopolysaccharides, amino acids, flavonoids, carbohydrates strigolactones, polymeric polyhydroxy acids, and terpenoids; Mined materials such as rock fertilizers, phosphate rock, potash, humate, bentonite, and nutrients; Biogenic materials such as diatomaceous earth, calcite, charcoal, kerogen, digestate, phosphorite, fish hydrolysate, humic acids, fulvic acids, humates, naturally obtained materials such as kelp, seaweeds, cottonseed meal, fish emulsion, sewage sludge, compost teas, liquid lime, yucca extract, and blood meal, sugars (mono and disaccharides) such as molasses, sorghum, corn syrup, sucrose, glucose, fructose, lactose, galactose, allose, altrose, mannose, gulose, idose, talose and maltose inoculants; Polymers and binders such as acrylics, vinyl acetates, polyvinyls, vinyls, styrenes, starches, fats, oils, proteins, shellacs, vinylidene chloride, vinylidene chloride copolymers, dextrin, molasses, sugars, alginates, plant derived and synthetic gums, chitosan, polyacrylamides (PAM), polysaccharides, monosaccharides, polylactic acid, polyglonic acid, polyethylenes, polychloroprene, alginic acid, pectic acid, celluloses, natural and synthetic waxes, kaolin clay, charcoal, and silicates; Seed treatment components such as colorants (dyes), solvents, surfactants, emulsion stabilizers, antifreeze compounds, adjuvants, inert fillers (vermiculte, talc, woodflours, clays, activated carbon, sugars, diatomaceous earth, cereal flours, fine-grain inorganic solids, calcium carbonate, calcium bentonite, kaolin, china clay, perlite, mica, silicas, quartz powders, montmorillonite etc.), and dessicants; Viroid control agents; RNA interface technology; Seed Disinfectants such as sodium hypochlorite, hydrogen peroxide, fatty acid monoesters, calcium hypochlorite, potassium permanganate, steam, hot humid air.

The term “seed treatment” includes the finished product of the present invention through its multiple forms and is applicable for all forms of seed coatings and enhancements. These include but are not limited to priming, solid matrix priming, pelleting, coating, dusting, encrustation, drenching, dressing, soaking, and any combination of these methods. In the above listing, methods used pertain to all forms and mixtures in single and additive products during and following seed coating and enhancement processes. In priming, additive products within a prescribed environment are used to initialize the physiological processes of the seed, while preventing germination until planting. The pelleting process involves adding substantial inert materials to seeds for ease of planting and emergence benefits. Coating involves material application with a binder for chemical adherence to the seed. Dusting involves adding a powdered substance to the seed for increased flow-ability and/or active enhancement compounds. Encrustation involves increasing the seed size with inert and active compounds beyond a film coating, while without greatly altering the seed's natural shape. Drenching involves multiple methods of the applying liquids to seeds, typically during planting. Using farm implements to apply seed enhancement products to the soil surrounding the seed is a method of use applicable for the present invention.

The term “seed” includes plant propagules of all types such as but not limited to true seeds, somatic embryos, synthetic seeds, seed pieces, suckers, corms, bulbs, fruit, tubers (eg. potatoes etc.), grains, cuttings, and shoots.

### Chemical Analysis of Composition

The composition was transferred into a Spectra Por Dialysis Membranes (MWCO 1000). Dialysis was performed against 4 L of running DI water at ambient temperature for one week to remove salt, monomers and other contaminants. After dialysis, the sample was lyophilized.

A butanol extraction protocol was utilized to try to identify any potential lipochitooligosaccharides (LCOs) contained in the composition. (Maillet et al., 2011; Prithiviraj et al., 2003). The final extracted sample was diluted in 18% Acetonotrile solution and injected into HPLC using C18 column with acetonitrile and water as the solvents. Each fraction was collected.

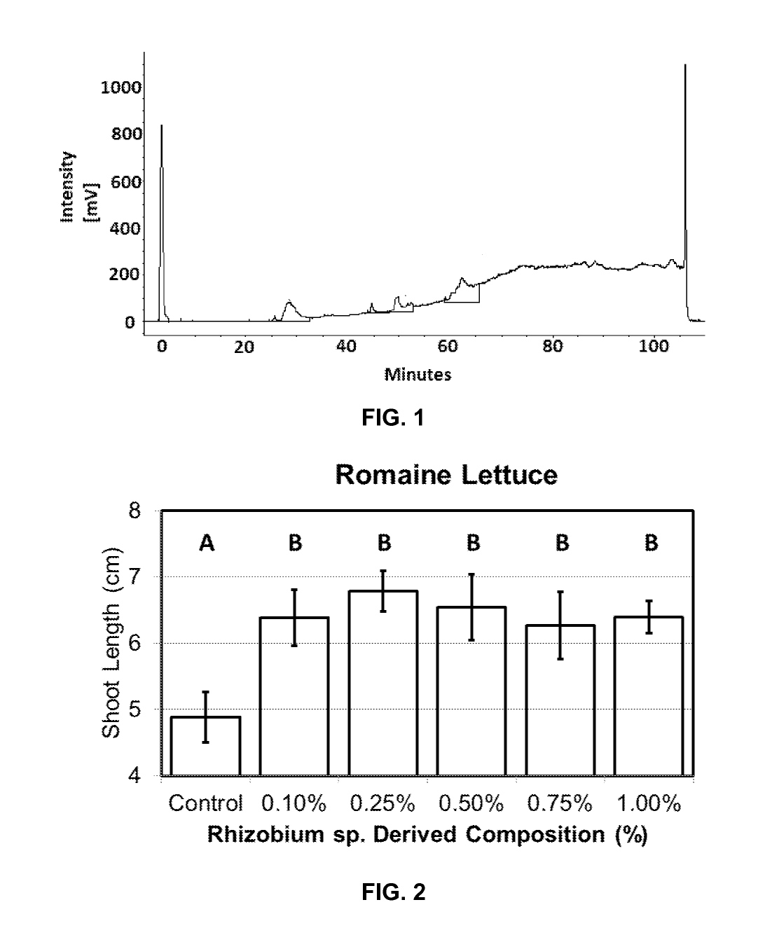

Acetonitrile from the collected fractions was evaporated under nitrogen and then redissolved in 30% acetonitrile and the sample was analyzed by matrix-assisted laser desorption/ionization (MALDI). MALDI/TOF-MS was performed in the reflector positive ion mode using α-dihyroxybenzoic acid (DHBA, 20 mg/mL solution in 50% methanol:water) as a matrix and the spectrum was obtained by using a Bruker microflex LRF (Bruker Daltonics Inc.). The spectra for is as given in FIG. 1. The obtained spectra did not show any presence of LCO's (D'Haeze and Holsters, 2002) as indicated by the lack of a sufficiently high signal to noise with the extraction protocols utilized. Flavonoids, when introduced into a culture of Rhizobium bacteria modulate and induce the production of LCOs. The most commonly utilized flavonoid is Naringenin, which is a known modulator and inducer of LCO production. No flavonoids are used in the production of the Rhizobium derived metabolite mixture and thus, no LCOs are expected and found.

The invention is further described in the following illustrative examples in which all parts and percentages are by weight unless otherwise indicated.

### EXAMPLES

### Example 1

Romaine lettuce seeds were tested in a sterile agar media that simulates a readily available soil nutrient package that includes a calcium chloride, a magnesium sulfate, a monopotassium phosphate, a potassium nitrate, and a ammonium nitrate in a nutrient agar. A Rhizobium spp. derived composition previously described is incorporated into the agar medium plate at several concentrations from 0.25% of the volume per plate to 1% of the agar media volume of the poured plate, ensuring that the overall amount of nutrients provided on each agar plate remains constant with the addition of the Rhizobium spp. derived composition. The nutrient agar is prepared by adding 20 g of agar to 1 L of water, heating the solution to activate the agar, then pouring the material into plates.

Romaine lettuce seeds are sterilized by quick immersion in a dilute (less than 0.1 M) sodium hypochlorite washing solution to eliminate any potential bacteria contamination in the lettuce seed during the length of the assay. Nine sterilized romaine lettuce seeds are then placed onto each agar medium plate test. Four replications for each test or rate are measured. The plates are placed in an incubator chamber for a period of 7 days in the dark and maintained at a constant 27° C. chamber. At the end of the 7 day assay, the seeds are removed and the shoot is measured. The resulting measurements are then averaged and compared.

Table 1 shows Rhizobium spp. derived composition concentration and the corresponding and resulting shoot length average for each of the concentrations showing a significant increase in the average length of the shoot of the Romaine lettuce seeds when in proximity to the Rhizobium spp. derived composition, even when composed on an optimum growth medium with an optimal availability of micronutrients. Results are shown in FIG. 2.

| | | | Statistical |
|---|---|---|---|
| Rhizobium spp. derived | Shoot Average | | Difference at |
| composition concentration | Length (n = 36) | STD | α = 0.05 |
| Control | 4.88 cm | 0.99 cm | A |
| 0.10% | 6.38 cm | 1.11 cm | B |
| 0.25% | 6.78 cm | 0.80 cm | B |
| 0.50% | 6.54 cm | 1.29 cm | B |
| 0.75% | 6.26 cm | 1.35 cm | B |
| 1% | 6.39 cm | 0.64 cm | B |

### Example 2

Field corn trial plots were planted in a partially randomized block design with four rows per block and one block for each treatment replication. Four replications are planted for each treatment at each location of the Rhizobium spp. derived composition plus a combination of consisting of fludioxonil, mefenoxam, azoxystrobin, thiabendazole, thiamethoxam and a control treated consisting only of fludioxonil, mefenoxam, azoxystrobin, thiabendazole, thiamethoxam (all components except Rhizobium spp. derived composition). The active rate of each of the components is in the range of 0.0001 mg of ai per seed to 1.25 mg of active ingredient (ai) per seed where the optimum rate is 0.0025 mg of azostrobin per seed, 0.0065 mg of fludioxonil per seed, 0.005 mg of mefenoxam per seed, 0.05 of thiabendazole per seed, 0.05 mg of thiamethoxam per seed, and 0.2 mg of Rhizobium spp. derived composition per seed. The individual blocks had a length of 20 feet. Portions at the end of the plot not used to plant blocks are planted with a filler. Edges of the field around the trials are planted with a filler variety of the same crop type so that all test areas are at least 20 feet from field edges.

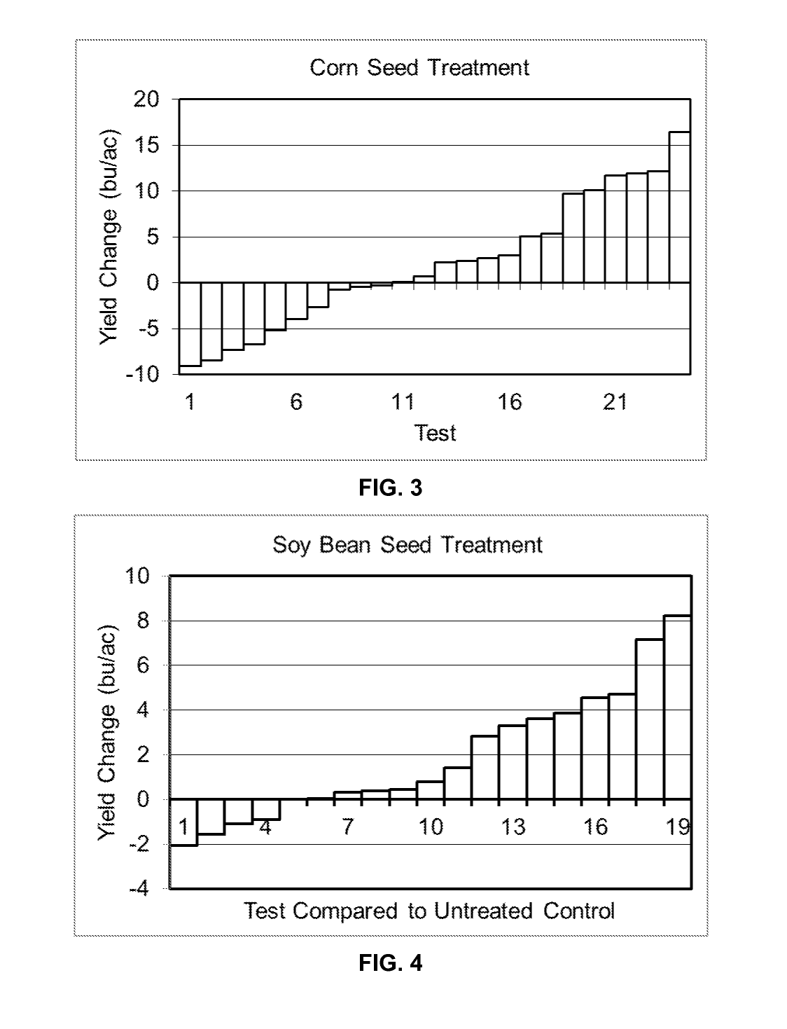

Each block is planted with four rows of commercially treated corn seed per treatment. For all the trials, two varieties are planted at each location. All treatments and one control are planted with four blocks (reps) per each treatment. Trials may be either center pivot irrigated or dry land (non-irrigated natural rainfall dependent). Standard production practices are followed uniformly for the field throughout the season. At harvest, the two center rows harvested for the field yield results. Each harvested block is moisture tested and corrected for actual yield to 15 percent moisture. The yield data for each replication and block is converted to a per acre value. Results are shown in FIG. 3.

### Example 3

Soy bean trial plots were planted in a partially randomized block design with four rows per block and one block for each treatment replication. Four replications are planted for each treatment at each location of the Rhizobium spp. derived composition plus a combination of consisting of ipconazole (0.005 mg/seed), imidacloprid (0.1 mg/seed), metalaxyl (0.006-0.02 mg/seed), and thiram (0.1 mg/seed), one control consisting only of ipconazole, imidacloprid, metalaxyl, and thiram (all components except Rhizobium spp. derived composition), and another control consisted of no treatment onto the seed. The individual blocks had a length of 20 feet. Portions at the end of the plot not used to plant blocks are planted with a filler. Edges of the field around the trials are planted with a filler variety of the same crop type so that all test areas are at least 20 feet from field edges.

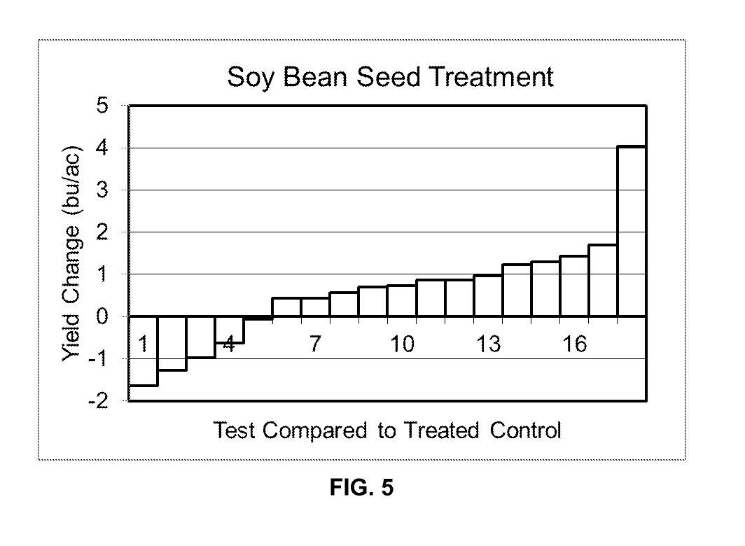

Each block is planted with four rows of treated soybean seed per treatment. For all the trials, two varieties are planted at each location. All test are planted with four blocks (reps) per each treatment. Trials may be either center pivot irrigated or dry land. Standard production practices are followed uniformly for the field throughout the season. At harvest, the two center rows harvested for the field yield results. Each harvested block is moisture tested and corrected for actual yield to 13 percent moisture. The yield data for each replication and block is converted to a per acre value. Results are shown in FIGS. 4 and 5.

### Discussion of Examples 1-3

In Example 1, the increased shoot length in the romaine lettuce seeds when in the proximity of the Rhizobium spp. derived composition is surprising. The increase on average from the un-augmented romaine lettuce agar plates to the Rhizobium spp. derived composition augmented plates from 4.88±0.99 cm to 6.39±1.11 cm, α=30.9% increase in the shoot length, at a concentration of 0.1% of the nutrient agar plate is surprising and unexpected. The results were statistically significant at α=0.05 for all treatment levels of the Rhizobium spp. derived composition as compared to the control and statistically similar for all treatment levels, indicating significant improvement by use of the composition that is statistically significant at a 95% confidence interval at all treatment levels. The plates were sterilized during preparation to ensure no living biologicals, or contaminants were impacting the results which further indicate that the Rhizobium spp. derived composition is involved in promoting early growth and vigor in a variety of treated plants. The use of a Rhizobium spp. derived composition does not involve the use of a living biological organism except that of the plant which is unique. Benefits can be seen with the use of a living biological, not the derived materials from a biological composition of a beneficial biological.

FIG. 2 is a chart plotting romaine lettuce shoot length against Rhizobium spp. derived composition percentage. FIG. 1 shows Agar plates containing an optimal mixture of nutrients showed significantly increased growth patterns when combined with a Rhizobium spp. derived composition at a wide range of composition percentages. All levels tested with the Rhizobium spp. derived composition resulted in a statistically significant response in the Romaine lettuce shoot length which is unexpected and novel.

In Example 2, harvested corn yields were compared between the treatment compositions containing the Rhizobium spp. derived composition vs without the Rhizobium spp. derived composition and reported as a yield change (i.e. difference between the two treatments) in bushels per acre (bu/ac). Each variety within a location was treated as an individual data point and is thus plotted as the average of the four replications of the composition treatment minus the average of four replications of the non-Rhizobium spp. derived composition control.

Yield increases were noticed in the comparison between the Rhizobium spp. derived composition treatment seed and the treated control which contained all of the same seed treatments except the Rhizobium spp. derived composition. A yield increase of 2.03 bu/ac was achieved over the treated control. This indicates a significant increase in the performance when using the Rhizobium spp. derived composition in conjunction standard chemical seed treatments. Generally, these types of increases would be attributable to only pest or disease prevention, not plant growth promotion (or biostimulation), especially in corn at the low application rates demonstrated.

FIG. 3 is a chart showing Corn seed treatment comparison between Rhizobium spp. derived composition plus chemical combination versus chemical composition without Rhizobium spp. derived composition indicating a 2.03 bu/ac increase when using the Rhizobium spp. composition over the non-Rhizobium spp. derived composition that represents a standard and widely utilized seed treatment composition.

Without wishing to be bound by theory, the hypothesis for the mechanism involves early season (early stage plant life) growth promotion and vigor of the plant which is induced by the Rhizobium spp. derived composition, which in turn results in improved yield. These results are unexpected from a composition derived from Rhizobium to show a response in corn. The amplitude of the results seen are also unexpected. A significant positive response by the addition of a Rhizobium spp. derived composition in corn is surprising. The low levels (0.2 mg/seed) at which the Rhizobium spp. derived composition is applied to the seed that results in a significant response is also surprising and novel.

In Example 3, harvested soybean yields were compared between the treatment composition containing the Rhizobium spp. derived composition vs without the Rhizobium spp. derived composition vs without any treatment and reported as a yield change (i.e. difference between the two treatments) in bushels per acre (bu/ac). Each variety within a location was treated as an individual data point and is thus plotted as the average of the four replications of the treatment minus the average of four replications of the non-Rhizobium spp. derived composition control or the average of four replications of the treatment minus the average of four replications of the non-treated seed.

Yield increases were noticed in both the comparison between the Rhizobium spp. derived composition treatment soybean seed and the non-treated (untreated control) and the treated control. A yield increase of 2.1 bu/ac was achieved over the non-treated control, and a yield increase of 0.63 bu/ac was achieved over the treated control. The percent positives (i.e. the number of times the Rhizobium spp. derived treated composition) resulted in a yield higher than the controls was 80% for the non-treated control and 72% for the treated control. This indicates a significant increase in the reliability and the performance when using the Rhizobium spp. derived composition in conjunction standard chemical seed treatments.

FIG. 4 is a chart showing soybean seed treatment comparison between Rhizobium spp. derived composition plus chemical combination versus composition without Rhizobium spp. derived composition indicating a 2.1 bu/ac increase when using the Rhizobium spp. composition over the non-Rhizobium spp. derived composition that is would represent a standard and often utilized seed treatment composition. In 80% of the test the Rhizobium spp. derived composition provided a positive response, i.e. a response above the untreated control

FIG. 5 is a chart showing soybean seed treatment comparison between Rhizobium spp. derived composition plus chemical combination versus composition without Rhizobium spp. derived composition indicating a 0.6 bu/ac increase when using the Rhizobium spp. composition over the non-Rhizobium spp. derived composition that is would represent a standard and widely utilized seed treatment composition. In 72% of the test, the Rhizobium spp. composition provided a positive response that is a yield that greater than the control for that individual test.

Without wishing to be bound by theory, the hypothesis for the mechanism involves early season growth promotion and vigor of the plant which is induced by the Rhizobium spp. derived composition, which in turn results in improved yield. The consistency (i.e. the percent positives) and the amplitude of the response is unexpected over the untreated seed and the base chemical seed treatment composition at the very low levels demonstrated (0.2 mg/seed) without the using of a living microbial Rhizobium. The amplitude of the results seen are also unexpected. The levels at which the Rhizobium spp. composition is applied to the seed that results in a response is very low and a surprising result. The other non-Rhizobium spp. derived chemicals are expected to produce a certain response over untreated seed but the response seen on top of those is unexpected. Living Rhizobium are known to produce an increase in nodulation but their performance is highly variable and inconsistent and limited to legume crops (Deaker, 2004). The consistency and amplitude of the response is uncharacteristic and unique.

Although the present invention has been described in considerable detail with reference to certain preferred versions thereof, other versions are possible. Therefore, the spirit and scope of the appended claims should not be limited to the description of the preferred versions contained herein.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C §112, sixth paragraph. In particular, the use of “step of” in the claims herein is not intended to invoke the provisions of 35 U.S.C §112, sixth paragraph.

What is claimed is:

1. A product comprising at least one Rhizobium spp. derived metabolite and a seed treatment material comprising at least one selected from the group consisting of a fungicide, an insecticide, a plant growth regulator, a plant growth promoter, a micronutrient, and combinations thereof.

2. The product according to claim 1, wherein the Rhizobium spp. derived metabolite is not derived from a lipochitooligosaccharide (LCO).

3. The product according to claim 1, wherein the fungicide is selected from the group consisting of metalaxyl, carboxin, menfenoxam, triticonazole, fludioxonil and combinations thereof.

4. The product according to claim 1, wherein the insecticide is selected from the group consisting of imidacloprid, thiamethoxam, clothianidin, cyromazine, permethrin and combinations thereof.

5. The product according to claim 1, wherein the plant growth regulator or promoter is selected from the group consisting of gibberellic acid, cytokinin, indolebutyric acid, kelp, indoleacetic acid, amino acid and combinations thereof.

6. The product according to claim 1, wherein the micronutrient is selected from the group consisting of zinc, copper, iron, molybdenum, manganese, and combinations thereof.

7. The product according to claim 1, wherein the nematicide is selected from the group consisting of abamectin, harpin, spinosad, chitin and combinations thereof.

8. The product according to claim 1, wherein the product is produced by a process comprising:
adding a broth to a biological reactor, wherein the broth comprises:
a carbon source, the carbon source comprising at least one monosaccharide and at least one higher order saccharide;
a source of nutrients, the source of nutrients comprising at least one phosphate, a nitrogen source, at least one source of magnesium; and
a Rhizobium spp.;
culturing the broth to produce a culture containing Rhizobium derived metabolites;
terminating viability of the culture by one selected from the group consisting of lysis, stabilization, thermal treatment, and combinations thereof; and
adding the seed treatment material to the culture to make a seed treatment composition.

9. The product according to claim 8, wherein the seed treatment composition is concentrated 2 to 10 times to produce a final composition that has an increased concentration of Rhizobium derived metabolites.

10. The product according to claim 8, wherein the Rhizobium spp. is a Rhizobiaceae.

11. The product according to claim 10, wherein the Rhizobiaceae is selected from the group consisting of Rhizobium etli, Rhizobium leguminosarum, Rhizobium phaseoli, Rhizobium tropici, Rhizobium fredii, Rhizobium meliloti, and combinations thereof.

12. A method comprising applying a product to one or more seeds, the product comprising at least one Rhizobium spp. derived metabolite and a seed treatment material comprising at least one selected from the group consisting of a fungicide, an insecticide, a plant growth regulator, a plant growth promoter, and combinations thereof.

11. The method according to claim 8, wherein the product is applied by one selected from the group consisting of film coating, encrusting, pelleting, priming, film coating, drenching, and combinations thereof.

12. The method according to claim 10, wherein the product is applied at a rate of from 0.00025 to 10 mg per seed.

13. The method according to claim 12, wherein applying the product increases the overall yield of the plants grown from the treated seed as compared to plants grown from seeds not treated with the product.

14. The method according to claim 12, wherein applying the product increases the harvestable fruit by at least 0.5 bushels per acre as compared to plants grown from seeds not treated with the product.

15. The method according to claim 12, wherein applying the product increases the harvestable foliage by at least 5% as compared to plants grown from seeds not treated with the product.

16. The method according to claim 12, wherein applying the product promotes the overall growth of the plant for the treated seed as compared to plants not treated with the product.

17. The method according to claim 12, wherein applying the product increases the overall growth of the plant for the treated seed as compared to the plants not treated with the product by at least 5% of the maximum above ground length.

18. A method for producing a product comprising at least one Rhizobium spp. derived metabolite and a seed treatment material comprising at least one selected from the group consisting of a fungicide, an insecticide, a plant growth regulator, a plant growth promoter, and combinations thereof, the method comprising:
adding a broth to a biological reactor, wherein the broth comprises:
a carbon source, the carbon source comprising at least one monosaccharide and at least one higher order saccharide;
a source of nutrients, the source of nutrients comprising at least one phosphate, a nitrogen source, at least one source of magnesium; and
a Rhizobium spp.;
culturing the broth to produce a culture;
terminating viability of the culture by one selected from the group consisting of lysis, stabilization, thermal treatment, and combinations thereof; and
adding the seed treatment material to the culture to produce the product.

19. A method of manufacturing a seed treatment composition comprising at least an exudates produced by Rhizobium spp. and one other seed treatment material, the Rhizobium composition method comprising;
cultivating a composition
adding a broth to a biological reactor, wherein the broth comprises:
a carbon source consisting of at least one monosaccharide and at least one higher order saccharide;
a source of nutrients comprising
one or more phosphates,
a nitrogen source,
at least one source of magnesium; and
a Rhizobium spp.;
allowing a culture of bacteria to grow in an aerobic biological reactor for 2-6 weeks;
adding at least one additional part carbon source to maintain the reactor in at least an excess of 4:1 of carbon to nitrogen to induce metabolite production;
stabilizing the Rhizobium spp. derived composition by concentrating the material rapidly by one selected from the group consisting of spray drying, flash drying, vacuum drying, evaporation, and combinations thereof; and
adding to the composition at least one other seed treatment material consisting of at least one fungicide.
